(19) United States
(12) Patent Application Publication
(10) Pub. No.: US 2026/0180392 A1
(43) Pub. Date: Jun. 25, 2026

(54) BATTERY TERMINAL WITH FLUID INGRESS MITIGATION

(71) Applicant: Milwaukee Electric Tool Corporation, Brookfield, WI (US)

(72) Inventors: Tyler J. Reaker, Milwaukee, WI (US); Mark C. Hughes, Waukesha, WI (US); Naguib O. Ghani, Milwaukee, WI (US); Kevin S. Puls, Milwaukee, WI (US); Carl F. Lyons, Milwaukee, WI (US); Jonathan L. Paul, Milwaukee, WI (US); Nathaniel A. Herrera, Oak Creek, WI (US)

(21) Appl. No.: 19/410,492

(22) Filed: Dec. 5, 2025

Related U.S. Application Data
(60) Provisional application No. 63/737,206, filed on Dec. 20, 2024.

(51) Int. Cl. H02K 5/22; B25F 5/02

(52) U.S. Cl. CPC H02K 5/225; B25F 5/02

(57) ABSTRACT

A connector block for a battery compartment of a power tool includes a support wall extending between a first end and a second end opposite the first end of the connector block, a base housing extending from the support wall adjacent the second end, and a plurality of battery terminals at least partially disposed in the base housing and extending towards the first end. The plurality of battery terminals include a first pair of terminals and a second pair of terminals spaced from the first pair of terminals. The base housing defines a plurality of base openings. At least one of the plurality of base openings is disposed between adjacent terminals of the plurality of battery terminals. The support wall defines a support wall opening extending defined between the second pair of terminals.

### CROSS-REFERENCE TO RELATED APPLICATIONS

This application is a non-provisional application claiming the benefit of priority under 35 U.S.C. § 119(e) to U.S. Provisional Application No. 63/737,206, filed Dec. 20, 2024, which is hereby incorporated by reference in its entirety.

### FIELD

The present disclosure relates generally to batteries, such as in some embodiments batteries for use with cordless tools such as handheld and/or outdoor battery-powered tools. More specifically, the present disclosure relates to battery terminals with fluid ingress mitigation features.

### BACKGROUND

Batteries are generally utilized to provide cordless electrical power. In the power tool industry, cordless tools such as handheld and/or outdoor battery-powered tools are becoming increasingly popular. One issue with known battery designs is battery-tool handshake failure due to battery terminal shorts. Such shorts can be caused by water and/or dendrite growth.

Accordingly, improvements which address the above-described issues are desired in the art and would be advantageous.

### BRIEF DESCRIPTION

Aspects and advantages of the present disclosure will be set forth in part in the following description, or may be obvious from the description, or may be learned through practice of the technology.

In accordance with one embodiment, a connector block for a battery compartment of a power tool is provided. The connector block includes a support wall extending between a first end and a second end opposite the first end of the connector block, a base housing extending from the support wall adjacent the second end, and a plurality of battery terminals at least partially disposed in the base housing and extending towards the first end. The plurality of battery terminals include a first pair of terminals and a second pair of terminals spaced from the first pair of terminals. The base housing defines a plurality of base openings. At least one of the plurality of base openings is disposed between adjacent terminals of the plurality of battery terminals. The support wall defines a support wall opening extending defined between the second pair of terminals.

In accordance with another embodiment, a power tool is provided. The power tool includes a housing having an electric motor and defining a battery compartment for receiving a battery. The battery compartment includes a connector block. The connector block includes a support wall extending between a first end and a second end opposite the first end of the connector block, a base housing extending from the support wall adjacent the second end, and a plurality of battery terminals at least partially disposed in the base housing and extending towards the first end for selective communication with the battery. The plurality of battery terminals include a first pair of terminals and a second pair of terminals spaced from the first pair of terminals. The base housing defines a plurality of base openings, and at least one of the plurality of base openings is disposed between adjacent terminals of the plurality of battery terminals. The support wall defines a support wall opening extending defined between the second pair of terminals. The power tool also includes a work element configured to be driven by the electric motor.

These and other features, aspects and advantages of the present disclosure will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present application, including the best mode of making and using the present systems and methods, directed to one of ordinary skill in the art, is set forth in the specification, which makes reference to the appended figures, in which:

FIG. 1 is a perspective view of a power tool in accordance with embodiments of the present disclosure;

FIG. 2 is a perspective view of a battery compartment of a power tool in accordance with embodiments of the present disclosure;

FIG. 3 is a perspective view of a connector block for the battery compartment of FIG. 2 in accordance with embodiments of the present disclosure;

FIG. 4 is a top view of the connector block of FIG. 3 in accordance with embodiments of the present disclosure;

FIG. 5 is a rear, perspective view of the connector block of FIG. 3 in accordance with embodiments of the present disclosure;

FIG. 6 is a cross-sectional view of the connector block of FIG. 3 along line VI-VI in accordance with embodiments of the present disclosure;

FIG. 7A is a perspective view of a plurality of battery terminals of the connector block of FIG. 3 in accordance with embodiments of the present disclosure;

FIG. 7B is a perspective view of a plurality of battery terminals of the connector block of FIG. 3 in accordance with embodiments of the present disclosure;

FIG. 7C is a side, perspective view of the plurality of battery terminals of FIGS. 7A and 7B in accordance with embodiments of the present disclosure;

FIG. 7D is a top view of the plurality of battery terminals of FIG. 7A in accordance with embodiments of the present disclosure;

FIG. 8 is a perspective view of a connector block for the battery compartment of FIG. 2 in accordance with embodiments of the present disclosure;

FIG. 9 is a rear, perspective view of the connector block of FIG. 8 in accordance with embodiments of the present disclosure; and

FIG. 10 is a top view of the connector block of FIG. 8 in accordance with embodiments of the present disclosure.

### DETAILED DESCRIPTION

Reference now will be made in detail to embodiments of the present disclosure, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, the present disclosure is related to batteries and battery terminals which prevent battery-tool handshake failure due to battery terminal shorts. Such shorts can be caused by water and/or dendrite growth. For example, a connector block for a battery terminal in accordance with the present disclosure may include (1) drain features immediately surrounding the battery terminal contacts and/or (2) a coating between terminals and the connector block to reduce electrical shorting across terminals in the event of fluid presence. Such improved battery terminals would reduce or eliminate water or other liquid pooling and advantageously prevent dendric growth between terminals.

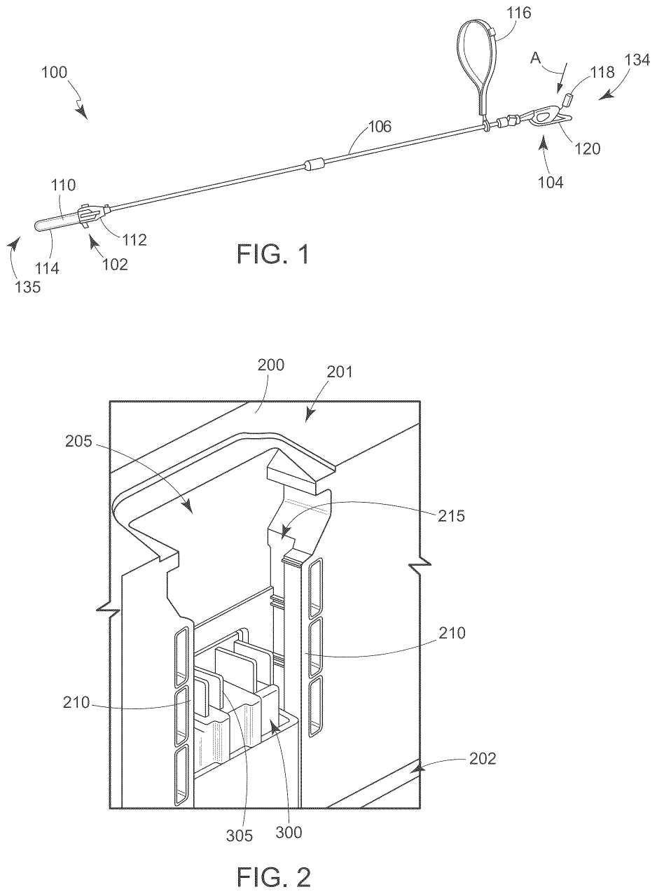

Referring now to the drawings, FIG. 1 illustrates a perspective view of a power tool 100 in accordance with embodiments of the present disclosure. In the exemplary emobdiment depicted, the power tool is a pole tool, such as a pole saw. However, it should be understood that the power tool 100 can include any power tool, such as a blower, a string trimmer, a hedge trimmer, an edger, or a chainsaw.

In at least one example embodiment, the power tool 100 generally includes a work element 102 and a housing 104. A motor (not shown) is disposed in the housing for driving the work element. For example, as shown in FIG. 1, the power tool 100 includes a shaft, such as a pole 106, extending between and connecting together the work element 102 and the housing 104. The housing 104 may be at a first end, such as a rear end 134, of the power tool 100 and the work element 102 may be at a second end, such as a front end 135, opposite the first end of the power tool 100.

In at least one example embodiment, the work element 102 of the power tool 100 is a sawing tool configured to cut material. The sawing tool includes a bar 110 extending from a work element housing 112. A chain 114 extends in an infinite loop around the bar 110 and is driven to move along a track of the bar 110. While holding the power tool 100 at the housing 104 and the pole 106, an operator can maneuver the sawing tool into position near an object, such as a branch, and urge the chain 114 into the object with the chain 114 in motion to cut the object. The operator can repeat this process as necessary. An optional shoulder or body strap 116 may be coupled to at least a portion of the power tool 100. For example, the optional shoulder or body strap 116 may be coupled to a portion of the pole 106 adjacent the housing 104. The optional shoulder or body strap 116 may be used for prolonged use of the power tool 100 to mitigate fatigue.

In at least one example embodiment, the chain 114 is driven by the motor (not shown). For example, the motor may be housed within the housing 104. A driveshaft can extend through the pole 106 to transfer power from the motor to the chain 114 through a chain sprocket. In other example embodiments, the motor may be housed within the work element housing 112 and drive the chain 114 through a chain sprocket.

In at least one example embodiment, the motor may be an electric motor, such as a direct current (DC) brushless motor. The motor includes an output shaft rotatably pinned to the chain sprocket, e.g., through a driveshaft. As the output shaft rotates, the chain 114 is driven within the track of the bar 110. In an example embodiment, the motor receives electrical power from a power source 118. For example, the power source 118 may include one or more batteries.

In at least one example embodiment, the power tool 100 includes a battery compartment 120 configured to receive the power source 118. For example, the battery compartment 120 may be configured to receive one or more batteries, such as at least two batteries, at least three batteries, or even at least four batteries. In at least one example embodiment, the power source 118 may be installed in the battery compartment 120 through a translational motion oriented in a direction shown by arrow A. In other example embodiments, the power source 118 may be installed in the battery compartment 120 through a translational motion oriented in another direction, in a rotational motion, or in a translational-rotational motion.

FIG. 2 illustrates a perspective view of a battery compartment 205 of a power tool 200 in accordance with embodiments of the present disclosure. The battery compartment 205 of the power tool 200 may be implemented into the power tool 100 of FIG. 1 as the battery compartment 120 of the housing 104. Additionally, the power tool 200 can include any power tool, such as the power tool 100, or pole saw, illustrated in the exemplary embodiment of FIG. 1 or a blower, a string trimmer, a hedge trimmer, an edger, or a chainsaw

As shown in FIG. 2, the battery compartment 205 extends between a first end 201 and a second end 202 opposite the first end 201. A receptacle for receiving power source 118, such as battery, may be defined from the first end 201 towards the second end 202. A guide rail 210 may extend between the first end 201 and the second end 202 of the battery compartment 205. Generally, the guide rail 210 may serve to guide or partially restrain the movement or mounted position of the power source 118. In such example embodiments, the guide rail 210 defines a channel 215 (e.g., extending between the first end 201 and the second end 201) within which a portion of the power source 118 is slidably received. As shown, the channel 215 may define an open space, such as a continuous gap, between at least a portion of a wall of the battery compartment 205 and the guide rail 210.

In at least one example embodiment, the guide rail 210 may be provided as or as part of a pair of guide rails 210. Thus, the guide rail 210 may include a pair of guide rails 210. As shown in FIG. 2, the pair of guide rails 210 may be disposed on opposing sides of the battery compartment 205.

With reference still to FIG. 2, a connector block 300 is disposed in the battery compartment 205 adjacent the second end 202. A plurality of battery terminals 305 are at least partially disposed in the connector block 300 and extend from the connector block 300 towards the first end 201. Generally, the plurality of battery terminals 305 is configured to electrically couple with the power source 118 (e.g., a battery). In turn, each of the plurality of battery terminals 305 may be in selective electrical communication with the power source 118. Moreover, the plurality of battery terminals 305 may be in electrical (e.g., wired) connection with a motor, controller, or any other electrically powered component of the power tool 100, 200 to provide power from the power source 118.

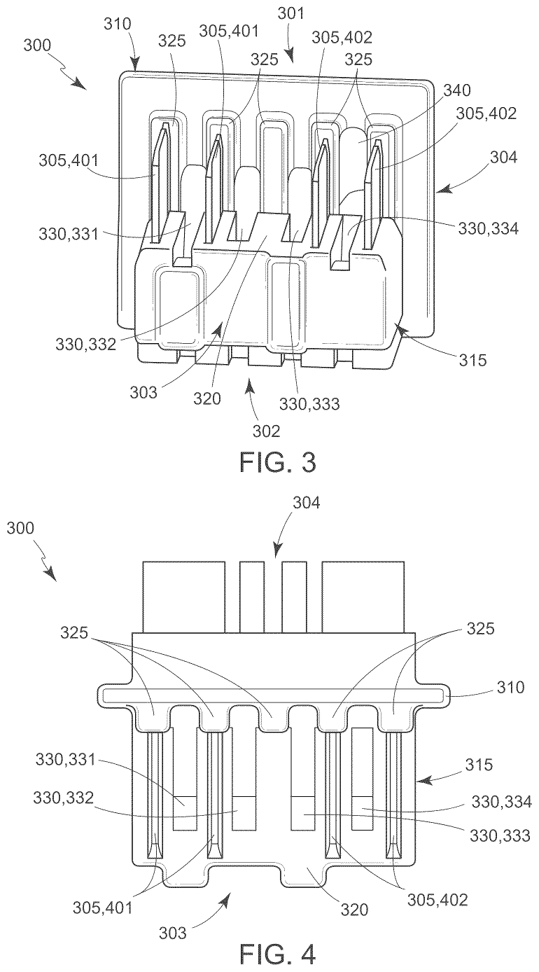

FIG. 3 illustrates a perspective view of the connector block 300 for the battery compartment 205 of FIG. 2 in accordance with embodiments of the present disclosure. FIG. 4 illustrates a top view of the connector block 300 of FIG. 3 in accordance with embodiments of the present disclosure. More specifically, FIG. 4 provides a view of the first end 301 of the connector block 300 of FIG. 3.

The connector block 300 includes a support wall 310 extending between a first end 301 and a second end 302 opposite the first end 301 of the connector block 300. The connector block 300 also includes a base housing 315 extending from the support wall 310 adjacent the second end 302. For example, the connector block 300 includes a front side 303 and a rear side 304 opposite the front side 303, and the base housing 315 extends from the front side 303 of the support wall 310.

The plurality of battery terminals 305 are at least partially disposed within the base housing 315 and extend out of an upper wall 320 of the base housing 315 towards the first end 301. Each of the plurality of battery terminals 305 may be coupled to at least a portion of the support wall 310. In at least one example embodiment, the front side 303 of the support wall 310 define a plurality of recesses (not shown), and edges of each of the plurality of battery terminals 305 may be inserted into one of the plurality of recesses. Moreover, as shown in FIG. 3, a plurality of projections 325 may extend from the front side 303 of the support wall 310, and one or more of the plurality of projections 325 may define one of the recesses for receiving at least an edge portion of one of the plurality of battery terminals 305.

In at least one example embodiment, the base housing 315 defines a plurality of base openings 330 extending from the first end 301 of the base housing 315 to the second end 302 of the base housing 315. At least one of the plurality of base openings 330 may be disposed between adjacent terminals of the plurality of battery terminals 305. For example, in at least one example embodiment, the plurality of battery terminals 305 include a first pair of terminals 401 and a second pair of terminals 402 spaced from the first pair of terminals 401. Additionally, the plurality of base openings 330 include a first base opening 331, a second base opening 332, a third base opening 333, and a fourth base opening 334. The first base opening 331 may be disposed between the first pair of terminals 401, the second base opening 332 and the third base opening are spaced apart and may disposed between the first pair of terminals 401 and the second pair of terminals 402, and the fourth base opening 334 may be disposed between the second pair of terminals 402.

The plurality of base openings 330 are configured to allow fluid, such as water, that may accumulate around the plurality of battery terminals 305 to drain away from the plurality of battery terminals 305 and out of the connector block 300. As mentioned above, as fluid accumulates around the plurality of battery terminals, such as between the plurality of battery terminals 305 and the connector block 300 and/or between the power source 118 (FIG. 1) and the plurality of battery terminals, the fluid can cause an electrical short that prevents activation of the power tool 100, 200 (FIGS. 1-2). Such electrical shorts can be caused by dendrites that form in the accumulated water. For example, silver ions forming the plurality of battery terminals 305 may dissolve and migrate into the accumulated water, which forms an electrical short when the water vaporizes. Accordingly, the plurality of base openings 330 provide pathways for the fluid to exit the connector block 300 and prevent such electrical shorts.

With reference to FIG. 3, the support wall 310 defines a support wall opening 340 extending between the front side 303 and the rear side 304 of the support wall 310. In at least one example embodiment, the support wall opening 340 is disposed between the second pair of terminals 402. Like the plurality of base openings 330 discussed above, the support wall opening 340 provides another pathway for fluid, such as water, that may accumulate adjacent the plurality of battery terminals 305 to exit the connector block 300.

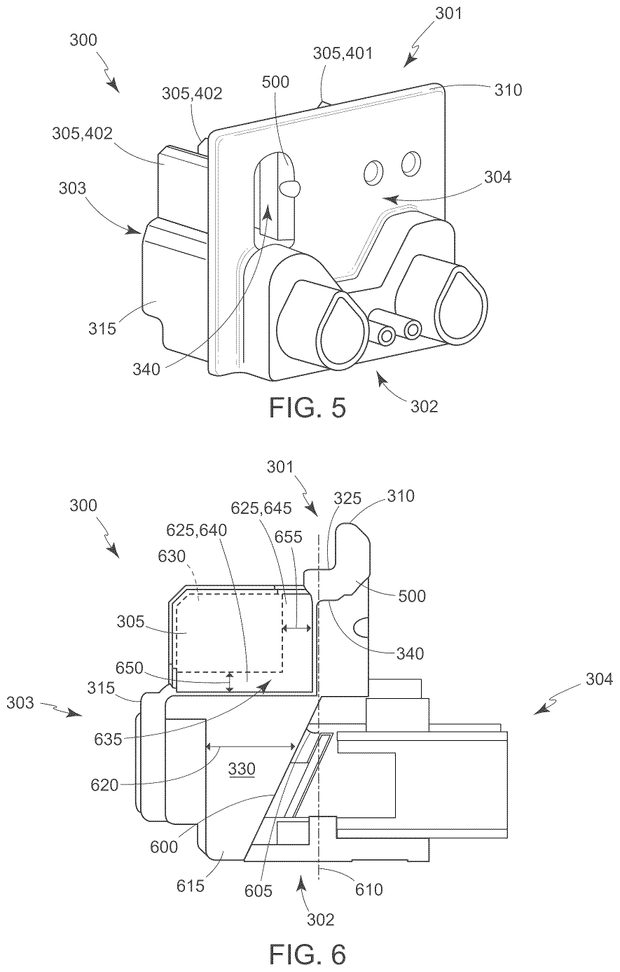

FIG. 5 illustrates a rear, perspective view of the connector block 300 of FIG. 3 in accordance with embodiments of the present disclosure. More specifically, FIG. 5 shows a view of the rear side 304 of the connector block 300. FIG. 6 illustrates a cross-sectional view of the connector block of FIG. 3 in accordance with embodiments of the present disclosure. More specifically, FIG. 6 illustrates a cross-sectional view through the fourth base opening 334 of the plurality of base openings 330 and the support wall opening 340 of the connector block 300.

With reference to FIGS. 5 and 6, the rear side 304 of the support wall 310 defines a chamfer 500 extending at least partially about a perimeter of the support wall opening 340. As mentioned above, the support wall opening 340 is configured to allow fluid, such as water, that may accumulate between the support wall 310 and the plurality of battery terminals (e.g., the second pair of terminal 402) or between the support wall 310 and the power source 118 (FIG. 1) when connected to the connector block 300 to drain away from the plurality of battery terminals 305 and out of the connector block 300. Moreover, the chamfer 500 increases the pressure differential between the front side 303 and the rear side 304 of the support wall opening 340 such that the fluid can flow more easily out of the connector block 300. For example, the chamfer 500 increases the diameter of the support wall opening 340 at the rear side 304 such that back pressure at the rear side 304 of the support wall opening 340 is reduced and fluid can flow out of the connector block 300 through the support wall opening 340.

With reference to FIG. 6, each of the plurality of base openings 330 define a substantially tapered shape extending from the first end 301 towards the second end 302 of the base housing 315. For example, a rear wall 600 of the base housing 315 that at least partially defines each of the plurality of base openings 330 extends at an angle 605 relative to a reference line 610 extending parallel to the support wall 310. In at least one example embodiment, the angle 605 may be less than 90 degrees. For example, the angle 605 may be 0 degrees such that the rear wall 600 is parallel with the support wall 310 and the reference line 610. Moreover, as shown in FIG. 6, a length 620 extending between the front side 303 and the rear side 304 of each of the plurality of base openings 330 may decrease from the first end 301 towards the second end 302.

The tapered shape of each of the plurality of base openings 330 enable each of the plurality of base openings 330 to serve as a reservoir for holding fluid that drains away from the plurality of battery terminals 305 and into the plurality of base openings 330 when the power tool 100, 200 (FIGS. 1-2) is tilted such that an outlet 615 of each of the plurality of base openings 330 is not facing downward to a surface to allow the fluid to exit the plurality of base openings 330. Accordingly, the fluid can still drain away from the plurality of battery terminals 305 and into the plurality of base openings 330 to prevent the power tool 100, 200 from shorting. In at least one example embodiment, one or more of the plurality of base openings 330 may have a cylindrical or ovular shape.

With reference still to FIG. 6, a coating 625 may be applied to at least a portion of each of the plurality of battery terminals 305. For example, the coating 625 may be applied to edges of each of the plurality of battery terminals adjacent the support wall 310 and the upper wall 320 of the base housing 315. More specifically, the coating 625 may be applied to a region of each of the plurality of battery terminals 305 that comes in electrical contact with the power source 118 (e.g., a battery). Fluid may enter gaps between one or more of the plurality of battery terminals 305 and the connector block 300 (e.g., between the plurality of battery terminals 305 and the support wall 310 and between the plurality of battery terminals 305 and the base housing 315) as well in in gaps or knit lines between components forming the connector block 300. Additionally, or alternatively, fluid may not immediately drain away from the plurality of battery terminals 305 and the connector block 300. Accordingly, the coating 625 is configured to prevent an electrical short due to the presence of fluid adjacent the plurality of battery terminals 305. The coating 625 is configured to provide electrical insulation, adhere strongly to each of the plurality of battery terminals 305, and provide high durability. In at least one example embodiment, the coating 625 may include an acrylic material. In additional example embodiments, the coating 625 may include a Parylene coating (e.g., a conformal coating, an enamel coating (e.g., a urethane and polyurethan coating), a resin and polymer coating (e.g., epoxy and polyester), or a combination thereof.

In at least one example embodiment, each of the plurality of battery terminals 305 include a first region 630 configured to electrically contact the power source 118 and a second region 635 outside of the first region 630 and at least partially surrounding the first region 630. The second region 635 is not intended to make electrical contact with the power source 118. The coating 625 is configured to be applied to the second region 635. For example, the second region 635 includes a first portion 640 adjacent the upper wall 320 of the base housing 315 and a second portion 645 adjacent the support wall 310. As shown, the second portion 645 is perpendicular to the first portion 640.

As shown in FIG. 6, the first portion 640 defines a first width 650 extending between the first end 301 and the second end 302, and the second portion 645 defines a second width 655 extending between the front side 303 and the rear side 304. In at least one example embodiment, the first width 650 is greater than or equal to 2.2 millimeters (mm) and less than or equal to 3.2 mm and the second width 655 is greater than or equal to 1.5 mm and less than or equal to 2.5 mm.

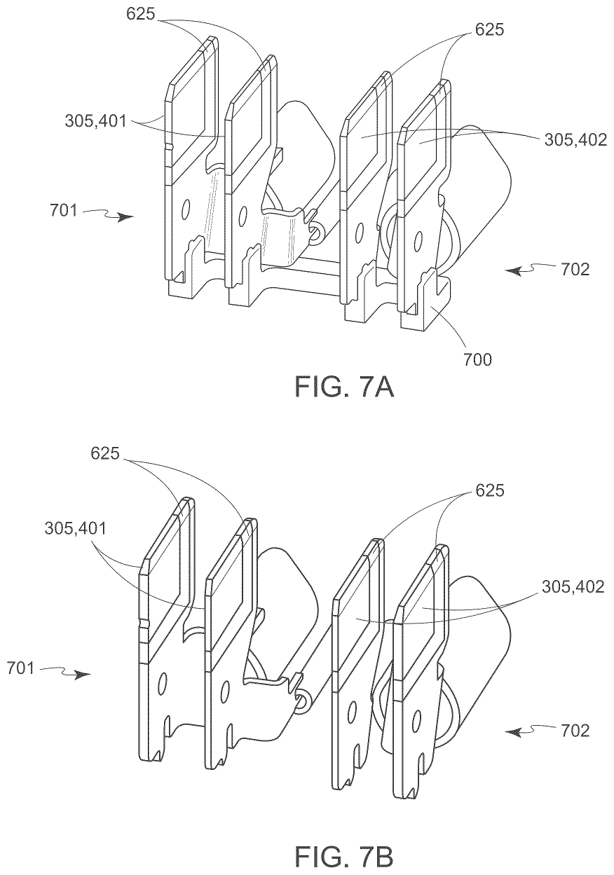

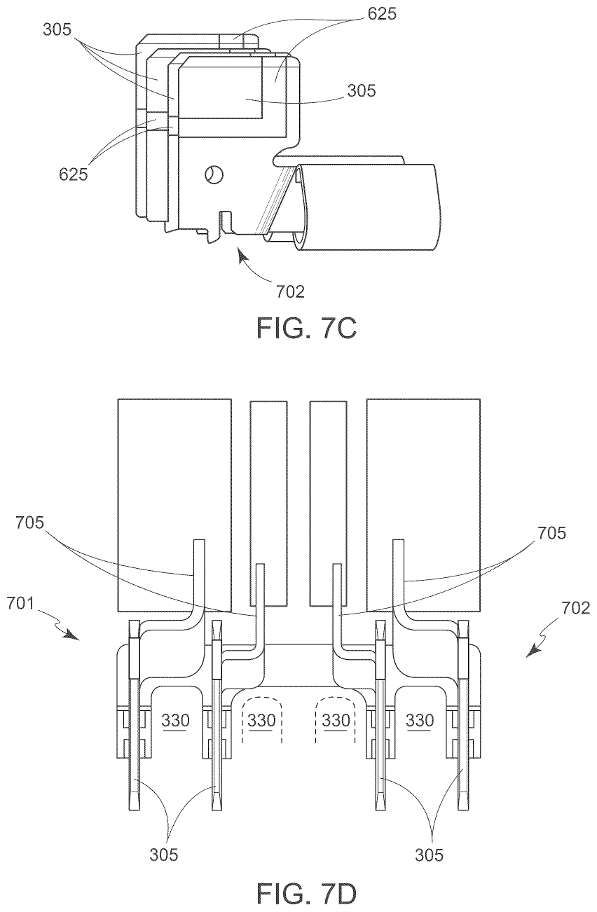

FIG. 7A illustrates a perspective view of the plurality of battery terminals 305 of the connector block 300 of FIG. 3 in accordance with embodiments of the present disclosure. FIG. 7B illustrates a perspective view of the plurality of battery terminals 305 of the connector block 300 of FIG. 3 in accordance with embodiments of the present disclosure. FIG. 7C illustrates a side, perspective view of the plurality of battery terminals 305 of FIGS. 7A and 7B in accordance with embodiments of the present disclosure. FIG. 7D illustrates a top view of the plurality of battery terminals 305 of FIG. 7A in accordance with embodiments of the present disclosure. More specifically, FIGS. 7A-7D illustrate the plurality of battery terminals 305 with the support wall 310 and the base housing 315 removed for clarity.

As shown in FIGS. 7A-7D, the plurality of battery terminals 305 extend substantially parallel to each other and are spaced between a first side 701 and a second side 702 opposite the first side 701. The plurality of battery terminals 305 may be evenly spaced or unevenly spaced in some example embodiments. In at least one example embodiment, as shown in FIGS. 7A and 7D, each of the plurality of battery terminals 305 may be coupled to a support member 700. The support member 700 may be disposed in the base housing 315 and configured to provide structural support and secure the plurality of battery terminals 305 within the base housing 315 of the connector block 300.

With reference to FIG. 7D, each of the plurality of battery terminals 305 include a flange 705 for securing the plurality of battery terminals 305 within the base housing 315 of the connector block 300. The flange 705 may have a substantially curved shape such that neither the plurality of battery terminals 305 nor the flange 705 extend into one of the plurality of base openings 330. Accordingly, the flange of each of the plurality of battery terminals 305 is configured to curve or extend around one or more of the plurality of base openings 330 such that the plurality of base openings 330 are unobstructed.

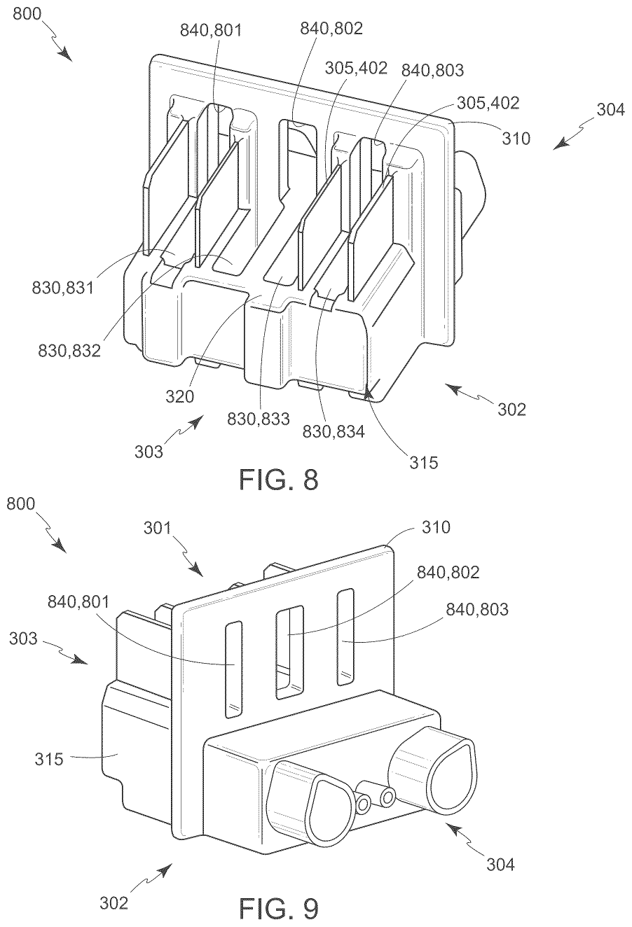

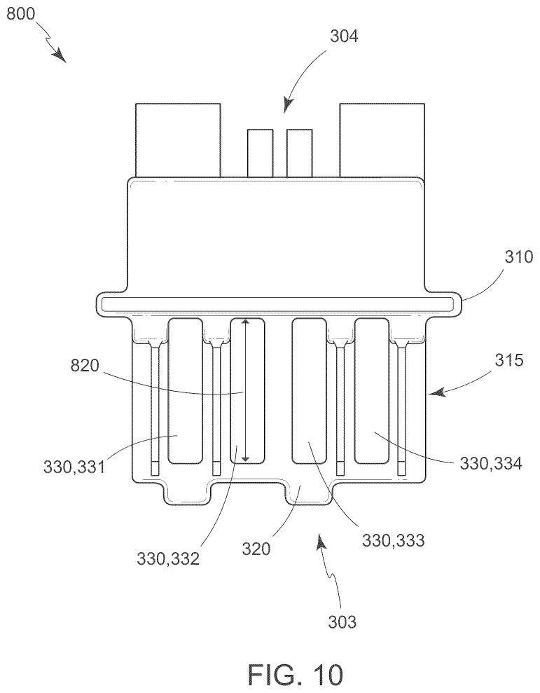

FIG. 8 illustrates a perspective view of a connector block 800 for the battery compartment 205 of FIG. 2 in accordance with embodiments of the present disclosure. FIG. 9 illustrates a rear, perspective view of the connector block 800 of FIG. 8 in accordance with embodiments of the present disclosure. FIG. 10 illustrates a top view of the connector block 800 of FIG. 8 in accordance with embodiments of the present disclosure. The connector block 800 may be similar or analogous to the connector block 300 discussed with respect to FIGS. 3-7D.

For example, the connector block 800 includes the support wall 310 extending between the first end 301 and the second end 302 and the base housing 315 extending from the front side 303 of the support wall 310 adjacent the second end 302. The plurality of battery terminals 305 are at least partially disposed within the base housing 315 and extend out of the upper wall 320 of the base housing 315 towards the first end 301. Each of the plurality of battery terminals 305 may also be coupled to at least a portion of the support wall 310.

The base housing 315 defines a plurality of base openings 830, including a first base opening 831, a second base opening 832, a third base opening 833, and a fourth base opening 834. The plurality of base openings 830 may be similar or analogous to the plurality of base openings 330. However, unlike the plurality of base openings 330 described with respect to FIGS. 3-6, the plurality of base openings 830 define a length 820 between the front side 303 and the rear side 304 that is substantially constant from the first end 301 to the second end 302, as shown in FIG. 10.

Moreover, the support wall 310 of the connector block 800 defines a plurality of support wall openings 840. The plurality of support wall openings 840 may be similar or analogous to the support wall opening 340 described with respect to FIGS. 3-6. However, as shown in FIGS. 8-9 the plurality of support wall openings 840 includes two or more of the plurality of support wall openings 840. For example, the plurality of support wall openings 840 include a first support wall opening 801, a second support wall opening 802, and a third support wall opening 803. The first support wall opening 801 is disposed between the first pair of terminals 401, the second support wall opening 802 is disposed between the first pair of terminals 401 and the second pair of terminals 401, and the third support wall opening 803 is disposed between the second pair of terminals 402.

In at least one example embodiment, the plurality of base openings 830 and the plurality of support wall openings 840 each define an ovular shape, a cylindrical shape, a rectangular shape, or any other suitable polygonal shape. Moreover, while the plurality of support wall openings 840 are illustrated without the chamfer 500 on the rear side 304 of the support wall 310 in FIG. 9, it should be understood that the support wall 310 may define the chamfer 500 about a perimeter of each of the plurality of support wall openings 840, as described with respect to FIG. 5.

Accordingly, the present disclosure provides a connector block for a battery compartment of various power tools that prevents fluid from accumulating adjacent the plurality of battery terminals. For example, the connector block defines a plurality of openings for allowing such fluid to flow away from the plurality of battery terminal and exit the connector block, which prevents electrical shorts from occurring. Additionally, or alternatively, a coating may be applied to at least a portion of each of the plurality of battery terminals. The coating may be electrically insulating such that an electrical short is prevented even if some fluid remains in contact with a portion of the plurality of battery terminals.

Further aspects of the disclosure are provided by one or more of the following embodiments:

A connector block for a battery compartment of a power tool, comprising: a support wall extending between a first end and a second end opposite the first end of the connector block; a base housing extending from the support wall adjacent the second end; a plurality of battery terminals at least partially disposed in the base housing and extending towards the first end, the plurality of battery terminals comprising a first pair of terminals and a second pair of terminals spaced from the first pair of terminals; wherein the base housing defines a plurality of base openings, at least one of the plurality of base openings disposed between adjacent terminals of the plurality of battery terminals; and wherein the support wall defines a support wall opening extending defined between the second pair of terminals.

The connector block of any one or more of the embodiments, wherein the plurality of base openings include a first base opening, a second base opening, a third base opening, and a fourth base opening, wherein the first base opening is disposed between the first pair of terminals, the second base opening and the third base opening are spaced apart and disposed between the first pair of terminals and the second pair of terminals, and the fourth base opening is disposed between the second pair of terminals.

The connector block of any one or more of the embodiments, wherein the connector block includes a front side and a rear side opposite the front side, wherein the base housing extends from the front side of the support wall, and wherein the rear side of the support wall defines a chamfer around a perimeter of the support wall opening.

The connector block of any one or more of the embodiments, wherein the plurality of base openings extend at an angle relative to a reference line extending parallel to the support wall.

The connector block of any one or more of the embodiments, wherein the angle is less than 90 degrees.

The connector block of any one or more of the embodiments, wherein the connector block includes a front side and a rear side opposite the front side, wherein each of the plurality of base openings define a length between the front side and the rear side.

The connector block of any one or more of the embodiments, wherein the length of each of the plurality of base openings decreases from the first end towards the second end.

The connector block of any one or more of the embodiments, wherein the length of each of the plurality of base openings is constant from the first end towards the second end.

The connector block of any one or more of the embodiments, wherein each of the plurality of battery terminals comprise a first region configured to electrically contact a power source and a second region at least partially surrounding the first region, wherein the second region comprises a first portion adjacent an upper wall of the base housing and a second portion adjacent a front side of the support wall perpendicular to the first region, wherein a coating is applied to the first portion and the second portion of each of the plurality of battery terminals.

The connector block of any one or more of the embodiments, wherein the second region does not electrically contact the power source, and wherein the power source comprises a battery.

The connector block of any one or more of the embodiments, wherein: the first portion defines a first width extending between the first end and the second end, the first width greater than or equal to 2.2 millimeters (mm) and less than or equal to 3.2 mm; and the second portion defines a second width extending between a front side and a rear side of the connector block, the second width greater than or equal to 1.5 mm and less than or equal to 2.5 mm.

The connector block of any one or more of the embodiments, wherein the support wall opening comprises a plurality of support wall openings.

The connector block of any one or more of the embodiments, wherein the plurality of support wall openings include a first opening disposed between the first pair of terminals, a support wall opening disposed between the first pair of terminals and the second pair of terminals, and a third opening disposed between the second pair of terminals.

The connector block of any one or more of the embodiments, wherein the plurality of base openings define a cylindrical or ovular shape.

The connector block of any one or more of the embodiments, wherein the support wall opening defines a cylindrical or ovular shape.

A power tool, comprising: a housing including an electric motor and defining a battery compartment for receiving a battery, the battery compartment comprising a connector block, the connector block comprising: a support wall extending between a first end and a second end opposite the first end of the connector block, a base housing extending from the support wall adjacent the second end, and a plurality of battery terminals at least partially disposed in the base housing and extending towards the first end for selective communication with the battery, the plurality of battery terminals comprising a first pair of terminals and a second pair of terminals spaced from the first pair of terminals, wherein the base housing defines a plurality of base openings, at least one of the plurality of base openings disposed between adjacent terminals of the plurality of battery terminals, and wherein the support wall defines a support wall opening extending defined between the second pair of terminals; and a work element configured to be driven by the electric motor.

The power tool of any one or more of the embodiments, wherein the plurality of base openings include a first base opening, a second base opening, a third base opening, and a fourth base opening, wherein the first base opening is disposed between the first pair of terminals, the second base opening and the second base opening are spaced apart and disposed between the first pair of terminals and the second pair of terminals, and the fourth base opening is disposed between the second pair of terminals.

The power tool of any one or more of the embodiments, wherein the connector block includes a front side and a rear side opposite the front side, wherein the base housing extends from the front side of the support wall, and wherein the rear side of the support wall defines a chamfer around a perimeter of the support wall opening.

The power tool of any one or more of the embodiments, wherein the plurality of base openings extend at an angle relative to a reference line extending parallel to the support wall.

The power tool of any one or more of the embodiments, wherein the angle is less than 90 degrees.

The power tool of any one or more of the embodiments, wherein the connector block includes a front side and a rear side opposite the front side, wherein each of the plurality of base openings define a length between the front side and the rear side.

The power tool of any one or more of the embodiments, wherein the length of each of the plurality of base openings decreases from the first end towards the second end.

The power tool of any one or more of the embodiments, wherein the length of each of the plurality of base openings is constant from the first end towards the second end.

The power tool of any one or more of the embodiments, wherein each of the plurality of battery terminals comprise a first region configured to electrically contact the battery and a second region at least partially surrounding the first region, wherein the second region comprises a first portion adjacent an upper wall of the base housing and a second portion adjacent a front side of the support wall perpendicular to the first region, wherein a coating is applied to the first portion and the second portion of each of the plurality of battery terminals.

The power tool of any one or more of the embodiments, wherein the second region does not electrically contact the battery.

The power tool of any one or more of the embodiments, wherein: the first portion defines a first width extending between the first end and the second end, the first width greater than or equal to 2.2 millimeters (mm) and less than or equal to 3.2 mm; and the second portion defines a second width extending between a front side and a rear side of the connector block, the second width greater than or equal to 1.5 mm and less than or equal to 2.5 mm.

The power tool of any one or more of the embodiments, wherein the support wall opening comprises a plurality of support wall openings.

The power tool of any one or more of the embodiments, wherein the plurality of support wall openings include a first opening disposed between the first pair of terminals, a support wall opening disposed between the first pair of terminals and the second pair of terminals, and a third opening disposed between the second pair of terminals.

The power tool of any one or more of the embodiments, wherein the plurality of base openings define a cylindrical or ovular shape.

The power tool of any one or more of the embodiments, wherein the support wall opening defines a cylindrical or ovular shape.

This written description uses examples to disclose the present application, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A connector block for a battery compartment of a power tool, comprising:
a support wall extending between a first end and a second end opposite the first end of the connector block;
a base housing extending from the support wall adjacent the second end;
a plurality of battery terminals at least partially disposed in the base housing and extending towards the first end, the plurality of battery terminals comprising a first pair of terminals and a second pair of terminals spaced from the first pair of terminals;
wherein the base housing defines a plurality of base openings, at least one of the plurality of base openings disposed between adjacent terminals of the plurality of battery terminals; and
wherein the support wall defines a support wall opening extending defined between the second pair of terminals.

2. The connector block of claim 1, wherein the plurality of base openings include a first base opening, a second base opening, a third base opening, and a fourth base opening, wherein the first base opening is disposed between the first pair of terminals, the second base opening and the third base opening are spaced apart and disposed between the first pair of terminals and the second pair of terminals, and the fourth base opening is disposed between the second pair of terminals.

3. The connector block of claim 1, wherein the connector block includes a front side and a rear side opposite the front side, wherein the base housing extends from the front side of the support wall, and wherein the rear side of the support wall defines a chamfer around a perimeter of the support wall opening.

4. The connector block of claim 1, wherein the plurality of base openings extend at an angle relative to a reference line extending parallel to the support wall, and wherein the angle is less than 90 degrees.

5. The connector block of claim 1, wherein the connector block includes a front side and a rear side opposite the front side, wherein each of the plurality of base openings define a length between the front side and the rear side.

6. The connector block of claim 5, wherein the length of each of the plurality of base openings decreases from the first end towards the second end.

7. The connector block of claim 5, wherein the length of each of the plurality of base openings is constant from the first end towards the second end.

8. The connector block of claim 1, wherein each of the plurality of battery terminals comprise a first region configured to electrically contact a power source and a second region at least partially surrounding the first region, wherein the second region comprises a first portion adjacent an upper wall of the base housing and a second portion adjacent a front side of the support wall perpendicular to the first region, wherein a coating is applied to the first portion and the second portion of each of the plurality of battery terminals.

9. The connector block of claim 8, wherein:
the first portion defines a first width extending between the first end and the second end, the first width greater than or equal to 2.2 millimeters (mm) and less than or equal to 3.2 mm; and
the second portion defines a second width extending between a front side and a rear side of the connector block, the second width greater than or equal to 1.5 mm and less than or equal to 2.5 mm.

10. The connector block of claim 1, wherein the support wall opening comprises a plurality of support wall openings, the plurality of support wall openings comprising a first opening disposed between the first pair of terminals, a support wall opening disposed between the first pair of terminals and the second pair of terminals, and a third opening disposed between the second pair of terminals.

11. A power tool, comprising:
a housing including an electric motor and defining a battery compartment for receiving a battery, the battery compartment comprising a connector block, the connector block comprising:
a support wall extending between a first end and a second end opposite the first end of the connector block,
a base housing extending from the support wall adjacent the second end, and
a plurality of battery terminals at least partially disposed in the base housing and extending towards the first end for selective communication with the battery, the plurality of battery terminals comprising a first pair of terminals and a second pair of terminals spaced from the first pair of terminals,
wherein the base housing defines a plurality of base openings, at least one of the plurality of base openings disposed between adjacent terminals of the plurality of battery terminals, and
wherein the support wall defines a support wall opening extending defined between the second pair of terminals; and
a work element configured to be driven by the electric motor.

12. The power tool of claim 11, wherein the plurality of base openings include a first base opening, a second base opening, a third base opening, and a fourth base opening, wherein the first base opening is disposed between the first pair of terminals, the second base opening and the second base opening are spaced apart and disposed between the first pair of terminals and the second pair of terminals, and the fourth base opening is disposed between the second pair of terminals.

13. The power tool of claim 11, wherein the connector block includes a front side and a rear side opposite the front side, wherein the base housing extends from the front side of the support wall, and wherein the rear side of the support wall defines a chamfer around a perimeter of the support wall opening.

14. The power tool of claim 11, wherein the plurality of base openings extend at an angle relative to a reference line extending parallel to the support wall, and wherein the angle is less than 90 degrees.

15. The power tool of claim 11, wherein the connector block includes a front side and a rear side opposite the front side, wherein each of the plurality of base openings define a length between the front side and the rear side.

16. The power tool of claim 15, wherein the length of each of the plurality of base openings decreases from the first end towards the second end.

17. The power tool of claim 15, wherein the length of each of the plurality of base openings is constant from the first end towards the second end.

18. The power tool of claim 11, wherein each of the plurality of battery terminals comprise a first region configured to electrically contact the battery and a second region at least partially surrounding the first region, wherein the second region comprises a first portion adjacent an upper wall of the base housing and a second portion adjacent a front side of the support wall perpendicular to the first region, wherein a coating is applied to the first portion and the second portion of each of the plurality of battery terminals.

19. The power tool of claim 18, wherein:
the first portion defines a first width extending between the first end and the second end, the first width greater than or equal to 2.2 millimeters (mm) and less than or equal to 3.2 mm; and
the second portion defines a second width extending between a front side and a rear side of the connector block, the second width greater than or equal to 1.5 mm and less than or equal to 2.5 mm.

20. The power tool of claim 11, wherein the support wall opening comprise a plurality of support wall openings, the plurality of support wall openings comprising a first opening disposed between the first pair of terminals, a support wall opening disposed between the first pair of terminals and the second pair of terminals, and a third opening disposed between the second pair of terminals.
